(19) United States
(12) Patent Application Publication
(10) Pub. No.: US 2019/0072232 A1
(43) Pub. Date: Mar. 7, 2019

(54) Tool Suspension Connector

(71) Applicant: Bru Tools, LLC, Windsor Locks, CT (US)

(72) Inventors: Kenneth Sabine, Windsor, CT (US); Zachary A. Mikulec, Brighton, MI (US)

(73) Assignee: Bru Tools, LLC, Windsor Locks, CT (US)

(21) Appl. No.: 16/121,613

(22) Filed: Sep. 4, 2018

Related U.S. Application Data
(60) Provisional application No. 62/553,353, filed on Sep. 1, 2017.

(51) Int. Cl. F16M 13/02; F16M 11/04; F16L 3/00; F16B 2/12; F16B 2/06; F16L 3/24

(52) U.S. Cl. CPC F16M 13/022; F16M 11/041; F16L 3/003; C12C 13/10; F16B 2/065; F16L 3/24; F16B 2/12

(57) ABSTRACT

A device, kit of parts, and method of connecting tools to a container or other object or surface are disclosed. The device may be attached to a side of a container or other surface or object. The device may include a riser which extends substantially up relative to an opening in the container. The device may also include a platform which may extend over or into the container. The platform may be substantially perpendicular to the riser. The riser, the platform, or both may include one or more openings configured to receive connectors, pipes, hose, lines, or other tools or instruments. One or more of the openings may be elongated so as to allow for selection of the height of the connected item or the amount of overhang into the container. One or more thumbscrews or optional washers may be included with the device.

### BACKGROUND

This application claims the priority of U.S. Provisional Patent Application No. 62/553,353 filed on Sep. 1, 2017, the disclosure of which is incorporated herein in its entirety.

The present disclosure relates generally to a device for connecting a first object to at least one other object. More particularly, the present disclosure relates to a device, kit of parts, and method of connecting a first item, such as a container, kettle, keg, vat, or other brewing-related container, to a second item, such as a brewing tool or other equipment which may be used for brewing beer or other drinks. One or more additional items may also be connected to the first item by means of the device and method.

It can often be difficult to connect items such as fittings, pipes, hoses, and various tools to a container with which those items must interact. Vats and other containers often include minimal, inconvenient, or no connection features, and items must be loosely hung over or into the container, must be supported by custom made connectors which may need to be permanently attached to the container or another nearby surface, or must be attached in such a way that use of the container and access during the brewing process is impeded.

As the brewing industry continues to grow, the number of brewing tools and methods of brewing also continues to increase. This is the case with both large-scale brewing systems as well as smaller, micro-brewing or home-brewing setups. Smaller setups, with fewer containers available for permanent or semi-permanent attachment of tools, present a particular set of problems when needing the use of assorted equipment during the brewing process. Some items may need to be inserted into a container and then removed, and a wide range of items may need to be used. These items may not always be desirable to seat inside of the container or against it in the same way, such as when one item needs to rest against an inside wall of the container, while another must be offset from the edge, or when it may not be desirable to have an item resting against the bottom of a container.

### SUMMARY

The present disclosure relates generally to a device for connecting a first object to at least one other object. More particularly, the present disclosure relates to a device, kit of parts, and method of connecting a first item, such as a container, to a second item, which may consist of or include such items as brewing tools or equipment which may be beneficial to have connected to a vat or other brewing-related container. Items may be connected adjustably, so that they can be connected at different heights or different offsets from a wall of the container. Items can also be connected removably, so that items may be exchanged for or replaced with other items as needed. A modular or variable system may be implemented so as to aid the user in effectively or efficiently using a range of instruments during the brewing process.

The device enables a user to temporarily, removably, adjustably, or permanently attach one or more fittings, pumps, hop arms, screens, whirlpool arms, chillers, faucets, coolant lines, piping, tools, other implements, or combinations thereof to one or both of the surfaces of the device or the container without needing to drill or otherwise create holes or connection points or features. The device may include a substantially horizontal surface, a substantially vertical surface, or both, one or both of which may be used for connections to one or more items. Multiple substantially horizontal or vertical surfaces may also be present. The device itself may be connected to an object, such as a container with a fully or partially open or openable end.

The device may be clamped to a surface or container, may be held in place by an adjustable, threadable, compressible, or friction-fit feature, or may be secured by welding, threading, bolting, cam locks, springs, clips, magnets, or other means known in the art. The device may be configured to support items such as pipes, hoses, pipe fittings, feeder lines, mixing tools, sparge arms, pumps, hop arms, screens, whirlpool arms, chillers, faucets, coolant lines, thermometers or other temperature gauges, temperature wells, hops containers, strainers, feeder lines, plate chillers, oxidation T's, wort chillers, and other tools and implements. Items may be connected to standard kegs, modified kegs, vats, boil kettles, pots, coolers, containers, sinks, tables, posts, and other items with either planar or curved surfaces. The device may also be connected to objects or surfaces with a lip feature, where one or more connection features may be located below or surrounding one or more lip features.

In one embodiment, the device is configured to connect two or more objects. The device includes a riser arm with a longitudinal axis and a deck plate. The deck plate has at least one surface which is substantially perpendicular to the longitudinal axis of the riser arm. One or both of the riser arm and the deck plate may include an opening which is configured to receive at least part of an item, such as a pipe, pipe fitting, tool, or other implement. In one embodiment, the device may be connected to a container or surface by means of welding, one or more screws, or other means known in the art. In another embodiment, the deck plate includes a compression feature which is offset from the riser arm and configured to seat at least partially against a feature, such as a wall, of the object being mounted to, such as a container. The compression feature may be on the opposing side of the wall or other feature of the container from at least part of the riser arm.

In another embodiment, the riser arm has an elongated opening. In another embodiment, the deck plate has an elongated opening. Both the riser arm and the deck plate may also have elongated openings.

In one embodiment, the riser arm may have an opening which is configured to receive an adjustable compression member, such as a threaded device like a thumbscrew. In another embodiment, the deck plate may have an opening which is configured to receive an adjustable compression member, such as a threaded device like a thumbscrew. One of the riser arm or the deck plate may be configured to receive a compression member, while the other includes a feature configured to oppose the compression member on an opposite side of a surface or container. If both are configured to receive a compression member, then the compression members may be configured to be opposed on opposite sides of a surface or container.

In one embodiment, the deck plate includes a platform which extends away from the riser arm. The deck plate may have a longitudinal axis which is configured at a perpendicular, acute, or obtuse angle relative to a surface of the riser arm. The platform may be configured to at least partially overhang an opening in an object, such as an open end of a container. The device or the deck plate may be reversible or may be configured to overhang away from the surface or container. The platform may extend away from the riser arm substantially perpendicular to it, or may extend at a different angle, such as one that is less than 90°.

In one embodiment, the platform of the deck plate may define an opening, such as an elongated opening configured for receiving or supporting tools or other items.

The device may be unitary, or it may be made up of multiple components. The deck plate may be attached to the riser arm and it may be removable from the riser arm. In one embodiment, either the deck plate or the riser arm may include a connection tab. The other of the deck plate or riser arm may include a slot or other connection feature configured to at least partially receive the connection tab. The deck plate and riser arm may also be non-removably attached to each other, such as by welding.

In one embodiment, the disclosed device is part of a kit of parts, which may include a connector and at least one washer. It may also include at least one thumb screw. Various disclosed embodiments or combinations of disclosed embodiments of the connector may be included in the kit of parts.

A method is disclosed, where a connector is placed proximate to a container or other item or surface. The connector may be attached to the container or surface, such as by screws, welding, or by compression. At least one item, such as a pipe or tool, may be attached to the connecter. The item may be removably attached, and more than one item may be used.

The method may include the use of a device which may include one or more of the features, steps, or components described herein. Any number of steps or elements may be used in conjunction with the method described, and various means for attaching or connecting to items may be incorporated.

It is to be understood that the above mentioned steps and features and the steps and features yet to be explained hereinafter can be used not only in the respectively mentioned combinations but also in other combinations or alone without departing from the context of the present invention.

### BRIEF DESCRIPTION OF THE DRAWINGS

The invention is now disclosed in detail with reference to exemplary embodiments shown in the accompanying drawings, where:

FIG. 1 shows a front top isometric view of an embodiment of the connector and a washer of the present disclosure;

FIG. 2 shows a side view of the embodiment of the connector of FIG. 1;

FIG. 3 shows a top view of the embodiment of the connector of FIG. 1;

FIG. 4 shows a front top isometric view of an embodiment of the connector of the present disclosure with two thumb screws and a container;

FIG. 5 shows a front top isometric view of another embodiment of the connector and washer of the present disclosure with two thumb screws, a pipe fitting, and a container;

FIG. 6 shows a side cross-sectional view of the embodiments of the connector, washer, two thumb screws, pipe fitting, and container of FIG. 5;

FIG. 7 shows a rear top isometric view of an embodiment of the connector and washer of the present disclosure with two thumb screws, a pipe fitting, a container, and a hop arm;

FIG. 8 shows a front top isometric view of an embodiment of the riser of the present disclosure;

FIG. 9 shows a front top isometric view of another embodiment of the riser of the present disclosure;

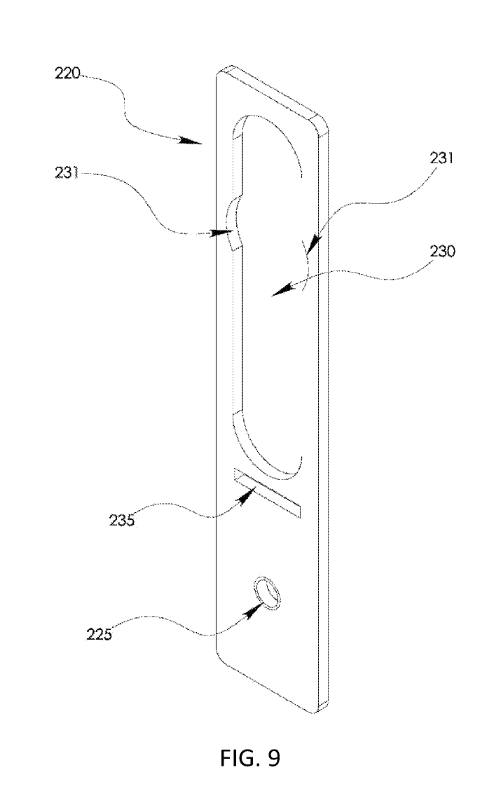

FIG. 10 shows a front top isometric view of an alternate embodiment of the riser of the present disclosure;

FIG. 11 shows a front top isometric view of another embodiment of the riser of the present disclosure;

FIG. 12 shows a front top isometric view of an embodiment of the deck plate of the present disclosure;

FIG. 13 shows a top view of the embodiment of the deck plate of FIG. 9;

FIG. 14 shows a front top isometric view of another embodiment of the deck plate of the present disclosure;

FIG. 15 shows a front top isometric view of an alternate embodiment of the deck plate of the present disclosure;

FIG. 16 shows a front top isometric view of an alternate embodiment of the riser of the present disclosure;

FIG. 17 shows a front top isometric view of an alternate embodiment of the connector of the present disclosure, including the embodiment of the deck plate of FIG. 15 and the embodiment of the riser of FIG. 16;

FIG. 18 shows a front top isometric view of another embodiment of the deck plate of the present disclosure;

FIG. 19 shows a front top isometric view of another embodiment of the riser of the present disclosure; and

FIG. 20 shows a front top isometric view of an alternate embodiment of the connector of the present disclosure, including the deck plate of FIG. 18 and the riser of FIG. 19.

### DETAILED DESCRIPTION

Exemplary embodiments of the disclosure are illustrated in the Figures and are explained in the following description in more detail, wherein identical reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, steps, and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

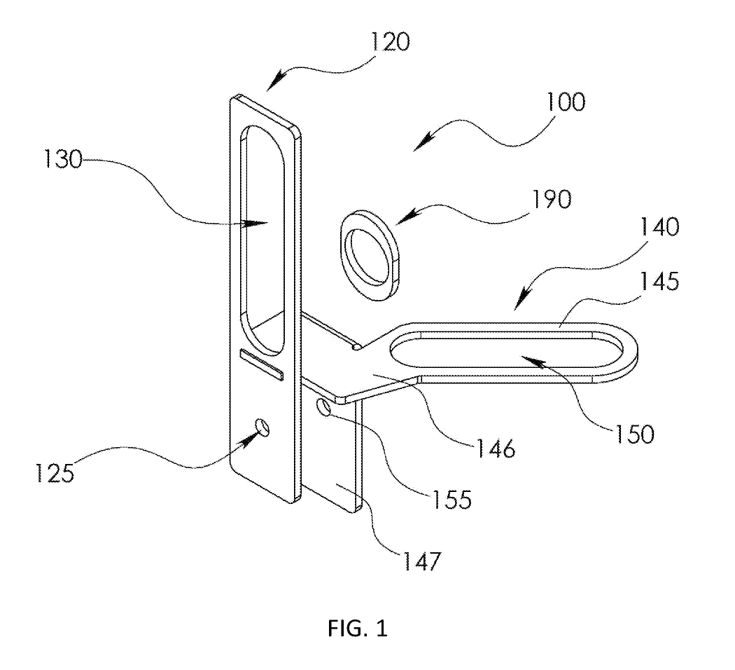

FIG. 1 shows an isometric view of an embodiment of the connector 100 of the present disclosure. An optional washer 190 is also shown. The connector 100 may include a riser member 120. The riser member 120 may have an opening 130, which may further be configured to receive pipes, tools, or connectors. The riser member 120 may also include a compression feature or second opening 125. The compression feature or second opening 125 may be threaded, such as to receive a thumb screw, or may be a through hole.

The connector may include a deck plate 140. The deck plate 140 may be substantially planar, and may be oriented substantially perpendicular to the riser member 120, or at any angle which may be deemed appropriate for connecting to a container 170 or for connecting tools or other items to the connector 100. The deck plate 140 may further include an opening 150, which may be substantially circular, elliptical, slot-like, or any other shape which may be deemed appropriate for receiving and/or supporting tools or other items. The deck plate opening 150 may be included on a platform feature 145 which may extend from the deck plate main body 146. The platform feature 145 may be parallel to the deck plate main body 146, may be at an angle to it, or may be offset from the deck plate main body 146, such as at an angle. The platform feature 145 may extend from the deck plate main body 146 substantially perpendicular to the riser member 120, or may extend from the deck plate main body 146 at an angle. The deck plate 140 may include a compression surface 147, which may be offset from the riser member 120 and may be substantially parallel to it. The compression surface 147 may be substantially planar, may be at least partially curved, or may include a notch, undercut surface, or other feature configured to aid in retention of the connector 100 to a container 170, or other object or surface. The deck plate 140 may also include a compression feature or opening 155, which may be a through hole or may be a threaded hole, such as for receiving a thumb screw, set screw, ball plunger, spring plunger, or other element configured to apply pressure to a container 170 or other surface.

The riser member 120 and deck plate 140 may be made of metal, such as steel or aluminum, plastic, a composite, or a combination of materials. The riser member 120 and deck plate 140 may both be made of the same material or different materials. The riser member 120 and deck plate 140 may be stamped, machined, molded, 3d printed, bent, folded, or made using other methods known in the arts.

The riser member 120 and deck plate 140 may be unitary, or may be connected. The riser member 120 and deck plate 140 may be removably connected or may be permanently connected, such as by means of unitary production, welding, deformation of connection features, adhesives, screws, bolts, sintering, or other means or methods known in the art. In one embodiment, the riser member 120 includes a connection slot 135 which may be configured to receive a connection tab 165 extending from the deck plate main body 146. The riser member 120 may be welded to the tab 165 or to other features or surfaces on the deck plate 140. It should be understood that other means of connection known in the art may also be used without deviating from the spirit or intent of this disclosure.

Though the washer 190 is shown as having both circular and planar faces, it should be understood that different shapes, including circles, ellipses, rectangles, and trapezoids may also be used. The washer 190 may be taller or may be wider that the width of the riser member 120 or of the platform 146 of the deck plate 140. The washer 190 may also be taller or may be wider than an opening 130, 150 in the riser member 120 or in the deck plate 140. In one embodiment, the washer 190 is taller than the width of the opening 130 of the riser member 120, but is less wide than the width of the opening 130 in the riser member 120. In such a fashion, the washer 190 may be slid through the opening 130 in one orientation, but provide a stop for fixation features being attached to the riser member 120 in other orientations. The washer 190, in such a configuration, may also be made of excess material cut, machined, or stamped from the riser member 120 itself. The washer 190 may be cut out of the riser member 120 when the opening 130 is being cut into the riser member 120, and may be used by rotation prior to compression against the riser member 120 so as to prevent passing through the opening in the riser member 120.

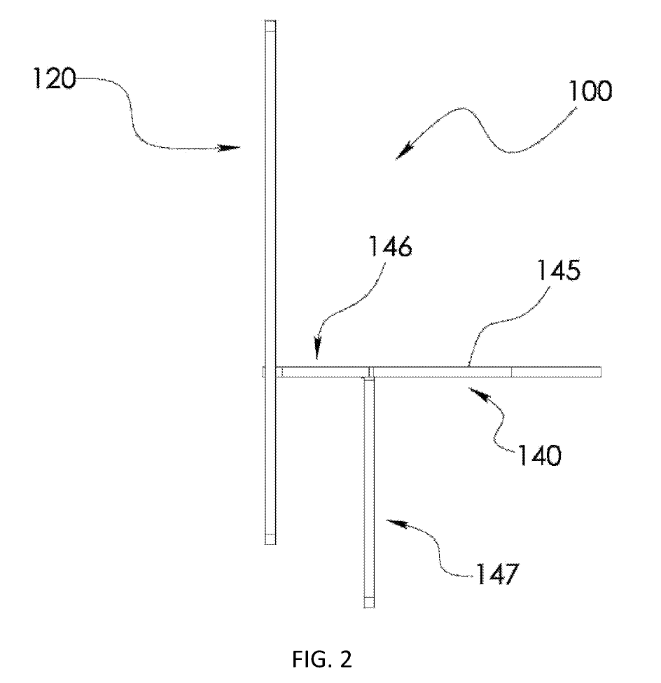

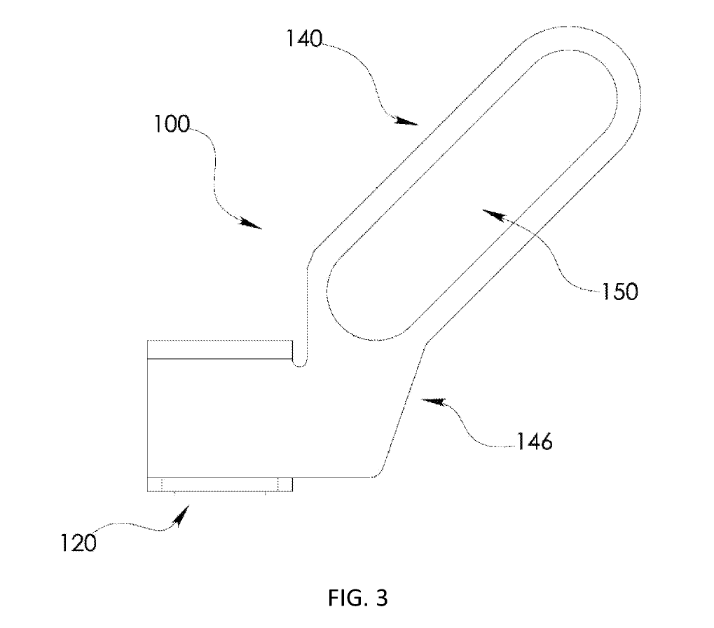

FIGS. 2 and 3 show a side view and a top view of the embodiment of the connector 100 of FIG. 1, respectively. The entire connector 100, the riser member 120, or the deck plate 140 may be molded, machined, cut, folded from sheet metal, or manufactured by other methods and means known in the art.

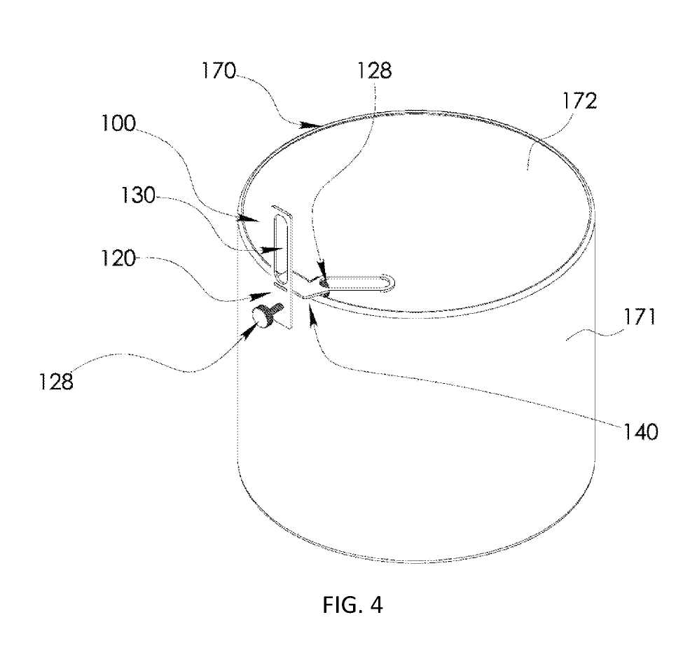

A connector 100 is shown attached to a circular container 170 in FIG. 4. The connector 100 is shown proximate to an open end 173 of the container 170, and is shown attached to the container 170 in such a way that at least part of the deck plate 140 extends above or into the opening 173. It should be understood that the container 170 may be completely open on at least one end, may be partially open, or may be completely or partially openable. A thumbscrew 128 is shown passing through the riser member 120 and contacting an outside side wall 171 of the container 170 so as to retain the connector 100 in position. A second thumb screw 128 is shown compressing the inner sidewall 172 of the container 170 from the inside of the container 170, though it should be understood that the second screw may 128 be located anywhere where sufficient compression may be created to retain the connector 100 against the container 170. It should also be understood that only one of the two screws 128 may be used in some embodiments, such as when the sidewall 171, 172 of the container 170 is compressed against a surface or feature of the riser member 120 or deck plate 140 and may not require a second source of compression. Other means of creating compression may also be used. A hook-like feature may also be used for compression, including but not limited to situations where the connector 100 is being attached to an object or surface which includes a lip or similar feature. Though a circular container 170 is shown, it should be understood that the connector 100 may be used with other containers, such as beer kegs, pots, kettles, or barrels, or with other devices or objects which include a surface wall to which the connector 100 may be attached. The connector 100 may be attached to objects with substantially planar or at least partially curved surfaces. When being attached to circular surfaces, point contact or curved contact at the compression feature, such as through the use of thumb screws 128, may be desirable.

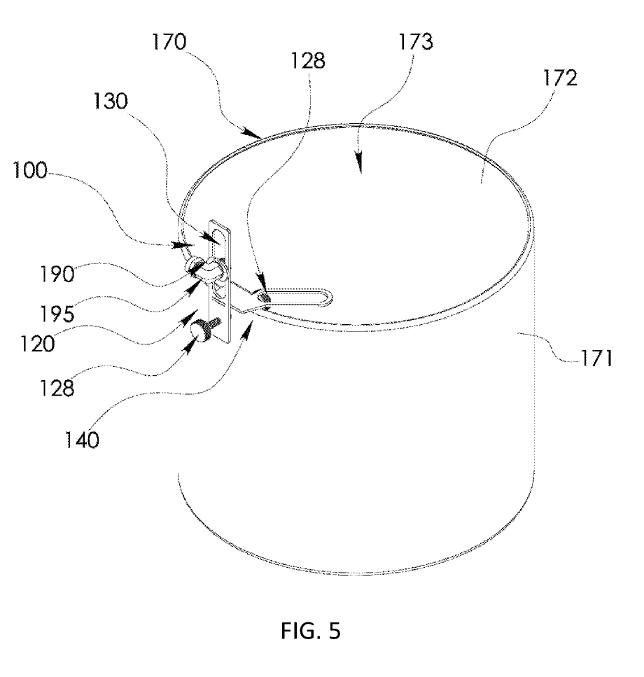

FIG. 5 shows another embodiment of the connector 100 attached to a container 170. A pipe fitting 195 is shown attached to a slot opening 130 in the riser member 120. A washer 190 is shown between the pipe fitting 195 and the riser member 120, though it should be understood that the washer 190 may be used on the other side of the riser member 120, a washer 190 may be used on an opening 150 in the deck plate 140, multiple washers 190 may be used, or no washer 190 may be used. Though a pipe fitting 195 is shown, other connectors, tools, and instruments may also be used. A pipe, hose, or other line may extend at least partially through the riser member 120. A pipe, hose, other line, or tool may extend at least partially through the deck plate 140. Some items which may be used and connected to the connector include water lines, hoses, chillers, hop arms, filters, thermometers, faucets, and other fermentation and brewing related equipment, though it should be understood that any other object or device may similarly be connected to or supported by the connector 100.

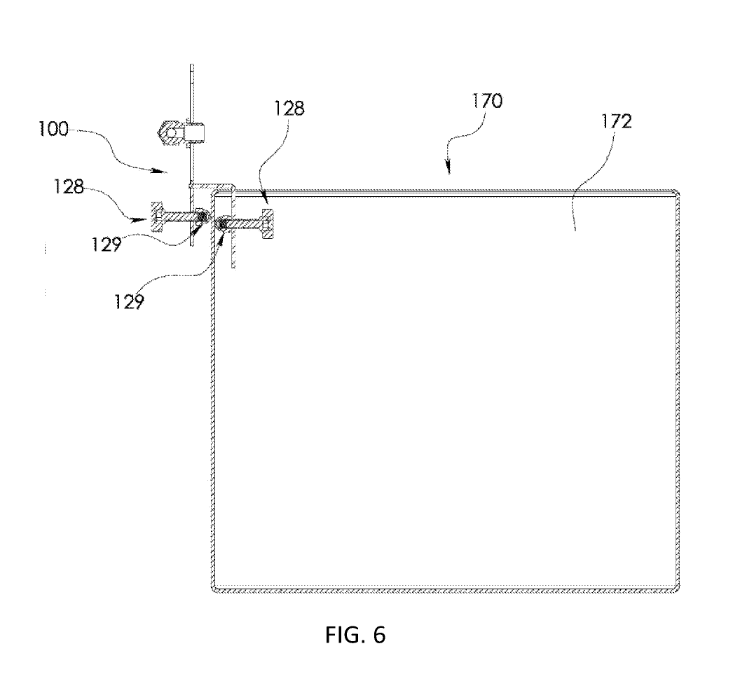

FIG. 6 shows a side sectional view of the embodiments shown in FIG. 5. Though two screws 128 do not need to be used, two are used in the embodiment shown to provide a benefit of being able to compress against an inside wall 172 of a container 170 when there is a lip or overhang on the container 170. A lip or overhand may prevent secure compression in some circumstances in the absence of at least one feature extending from the primary surface of the deck plate compression surface 147. The screw 128 may be unitary, or may be made of components such as a cap 129, a threaded screw, and a thumb screw head. The components may each separately or together be made of plastic, metal, composites, or other materials. In one embodiment, the cap 129 may be made of nylon or a similar soft material so as not to damage the container. A thumb screw head may be made of plastic or another material which may be configured to be easily gripped or manipulated by a user.

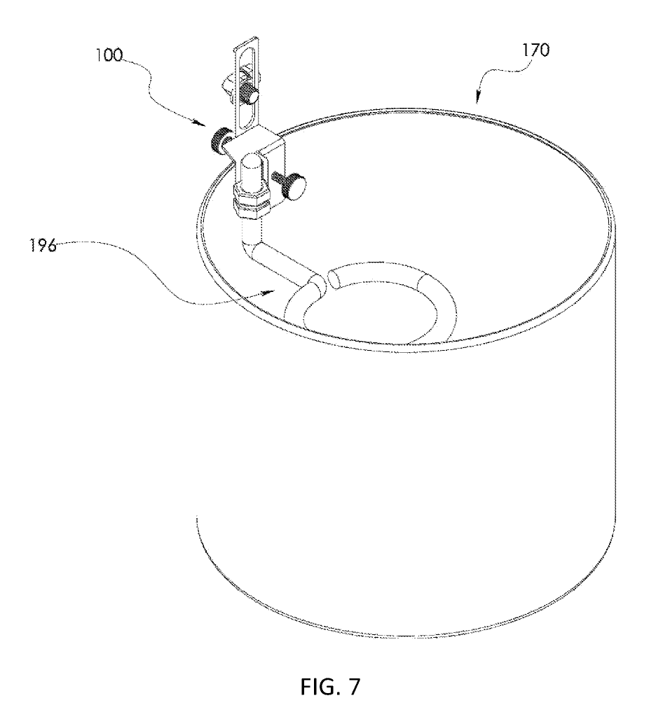

FIG. 7 shows an embodiment of the connector 100 attached to a container 170. In the embodiment shown, a hop arm 196 is shown attached to the connector, without a bag or other mesh container for hops. It should be understood that other tools may also be attached to the connector 100 in similar fashion, such as a holding screen to retain hop material after boiling, a whirlpool arm, a temperature well, a chiller such as a copper immersion chiller or a plate chiller, and other items and tools of benefit to brewing and other similar processes.

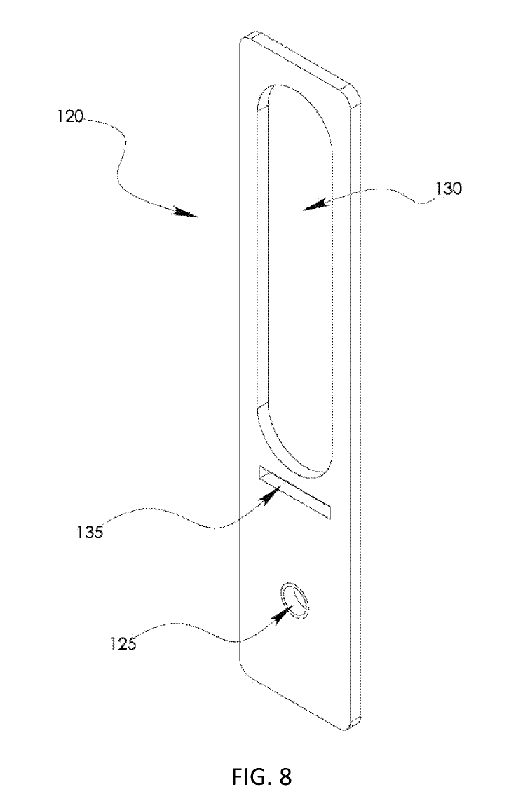

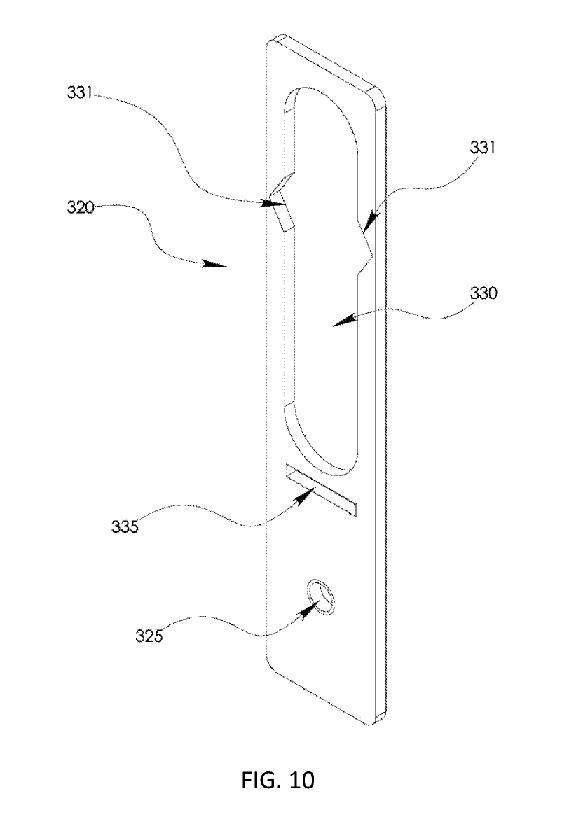

FIG. 8 shows an embodiment of the riser member 120 of the present disclosure. The riser member 120 may include a compression feature 125, such as a hole, which may be threaded in some embodiments. FIG. 8 shows an alternate embodiment of a riser member 220. The riser member 220 may include an opening 230, such as a slot, which may be configured for connection to or passing through of hoses, pipes, pipe fittings, quick connectors, or other connectors or tools. The opening 230 may be substantially elongated to enable a user to select from a variety of locations along the height of the riser member 220 for connection of a pipe, hose, or other instrument. A user may insert an item directly into the opening 230 and slide it to a desired height, or to a height required by the height of the item, size and shape of an attached instrument, or so as to suspend an item within a container 170 without touching a sidewall 172 or without touching the bottom of the container 170. When using an item such as a copper immersion chiller, it may be desirable to avoid having the chiller contact the bottom or sidewalls of the container 170. Items which already include an attachment means, such as a pipe which may already have threaded connectors on it, may be inserted through the enlarged opening of the notches 231 shown in FIG. 8. The item may then be slid into position and the connection means may be tightened. Though the notches 231 are shown substantially circular, it should be understood that other shapes may also be used, such as triangular cuts 331, rectangular cuts, curved cuts, and any other shape deemed appropriate for user needs. FIG. 10 shows an embodiment of the riser member 320 which includes substantially triangular notches 331.

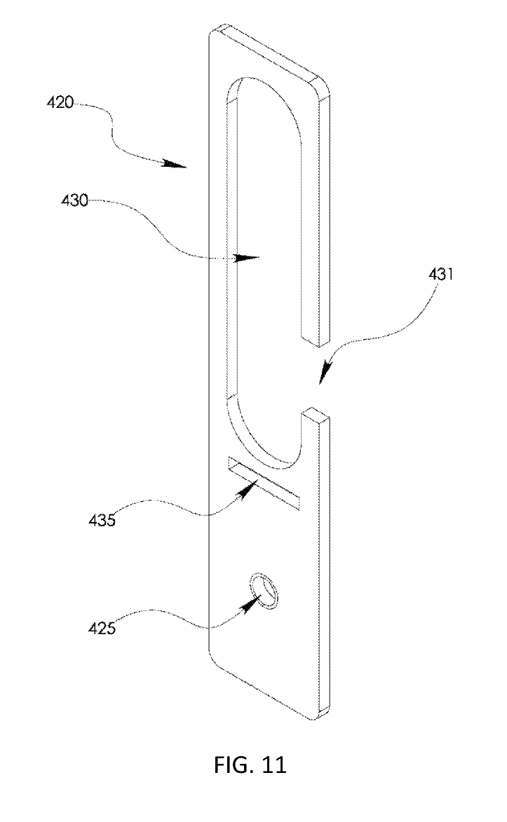

It should be understood that multiple notches 231, 331, a single notch 231, 331, or no notches 231, 331, may be used without deviating from the scope and intent of this disclosure. FIG. 11 shows an embodiment of the riser member 420 which includes a cut-out 431 to allow for insertion of a pipe or implement with connection or other features which may prevent sliding the item directly through the slot 430.

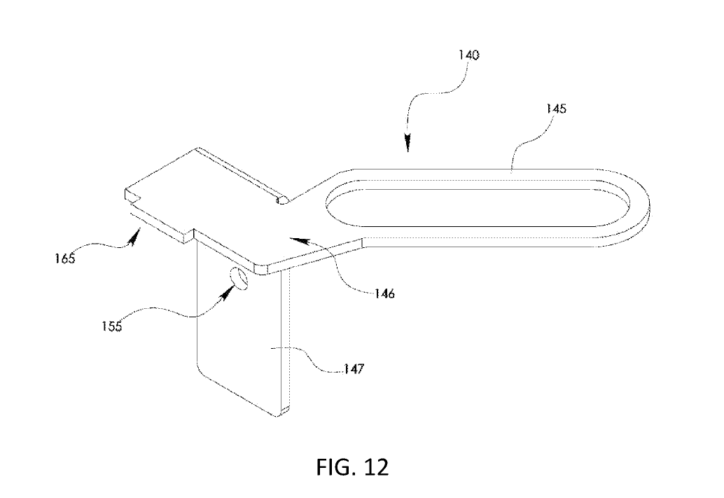

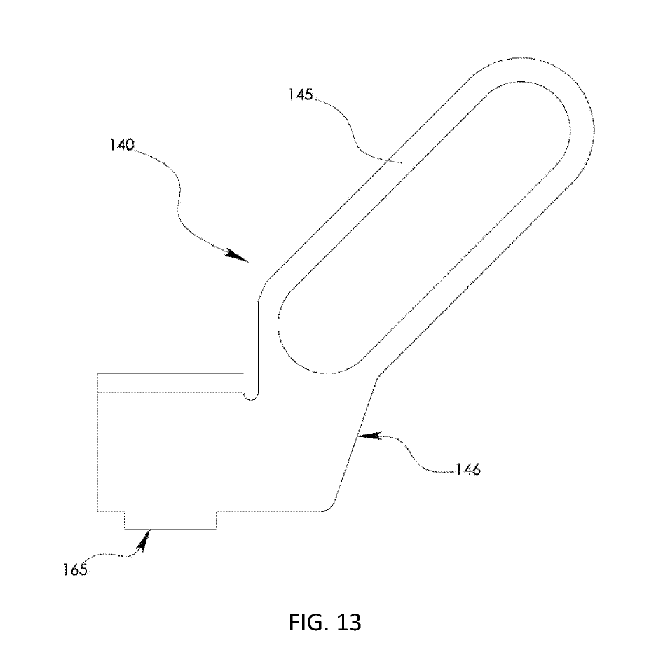

FIGS. 12 and 13 show an embodiment of the deck plate 140 from a front top isometric view and a top view, respectively. The embodiment shown includes a platform 145 which is substantially parallel to the main body 146 of the deck plate 140 and extends at an angle. It should be understood that the angle of the platform 145 relative to the main body 146 of the deck plate 140 may be varied to accommodate different users, uses, or implements which may be connected to or pass through the platform 145. It should be understood that the compression surface 147 of the embodiment of FIG. 11 can be offset further or less in different embodiments from the deck plate tab 165 to allow for connection to different containers, surfaces, or other items, as well as where different overhangs or compression strengths may be desired.

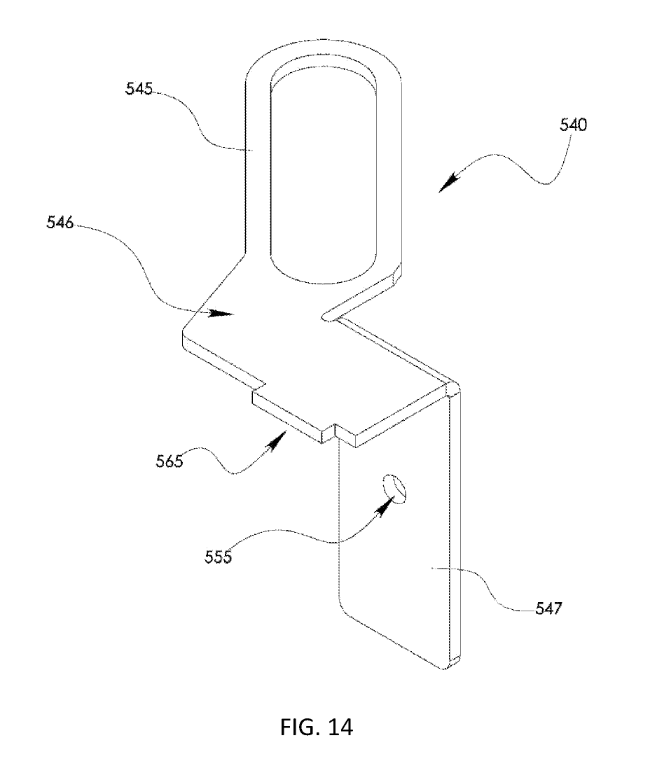

FIG. 14 shows an embodiment of the deck plate 540. In this embodiment, the platform 545 extends substantially to the left of the deck plate main body 546, as opposed to the right extension of the embodiment of the deck plate 140 of FIG. 11. Different angles and directions may be used, and such “right handed” or “left handed” deck plates 140, 540 may be desirable for different uses or users.

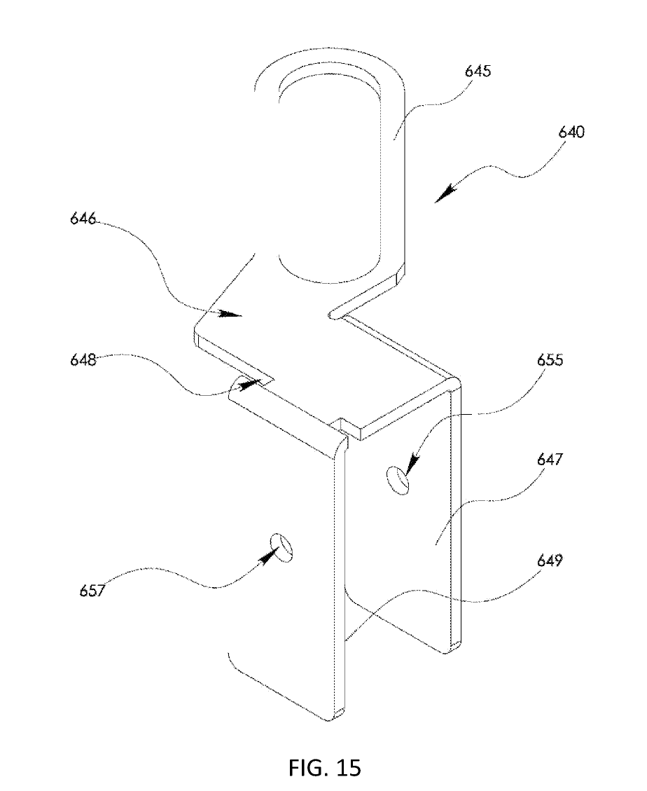

FIG. 15 shows an alternate embodiment of the deck plate 640 of the present disclosure. In this embodiment, the deck plate 640 includes a front compression surface or feature 649. It may include a rear compression surface or feature 647, though that surface or feature may alternately be part of the rise plate 620 as well. The deck plate 640 includes a notch 648 which may be slide into or otherwise connected to a mating feature 635, though it should be understood that the deck plate 640 and the riser member 620 may be connected through other means, as previously discussed. The deck plate 640 may include a connection or compression feature 657, such as a threaded opening, in the front compression surface or feature 649.

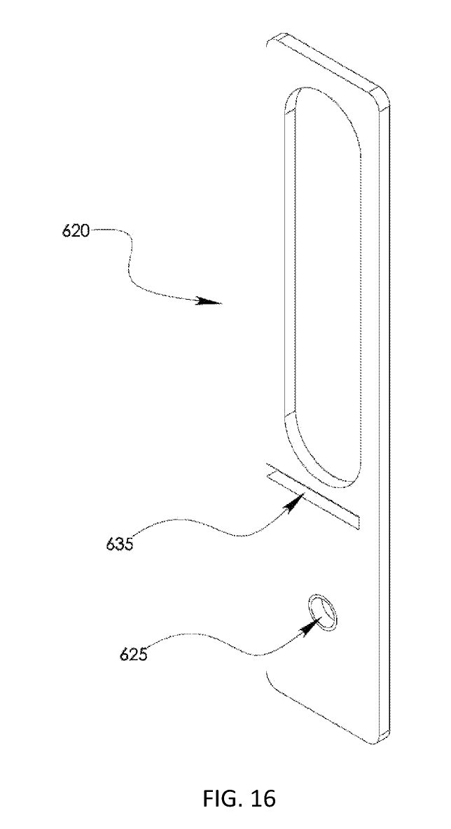

An alternate embodiment of the riser member 620 is shown in FIG. 16. The riser member 620 may include a notch or mating featuring 635 to connect with or aid in connection of the deck plate 640 to the riser member 620. In the embodiment shown, the riser member 620 does include a connection feature 625, shown as a threaded, though the connection feature 625 may not be necessary in all embodiments, such as where the deck plate 640 includes a connection feature 657. Where the deck plate 640 includes a connection feature 657 and the riser member 620 also includes a connection feature 625, it may not be necessary for both to be threaded. In one embodiment, the riser member 620 connection feature 625 is threaded and the deck plate 640 connection feature 657 is not. In an alternate embodiment, the threading and through hole are reversed. It should also be understood that neither opening needs to be threaded, such as where a thumb screw 128 is used which threads into a threaded nut that then compresses against other features of the connector 600.

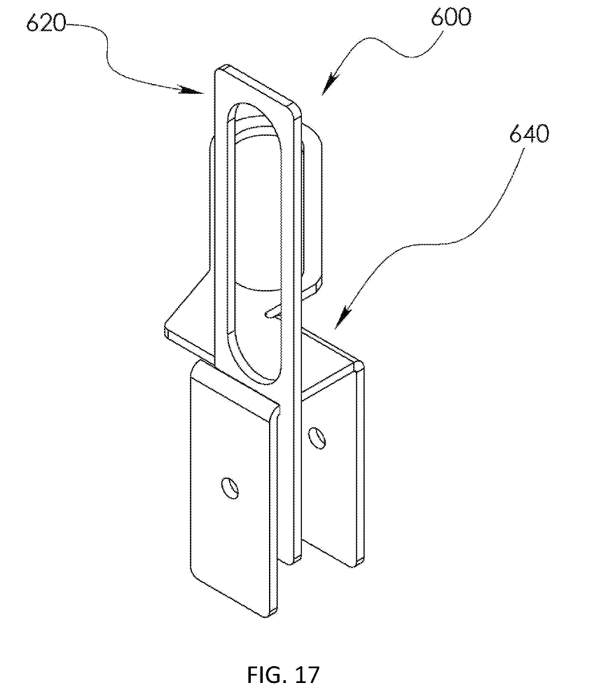

FIG. 17 shows an embodiment of the connector 600 which includes the deck plate 640 of FIG. 15 and the riser member 620 of FIG. 16. The deck plate 640 and the riser member 640 may have surfaces or features which are layered upon each other, such as where additional strength is desired, improved connections, or ease for ease of manufacturing.

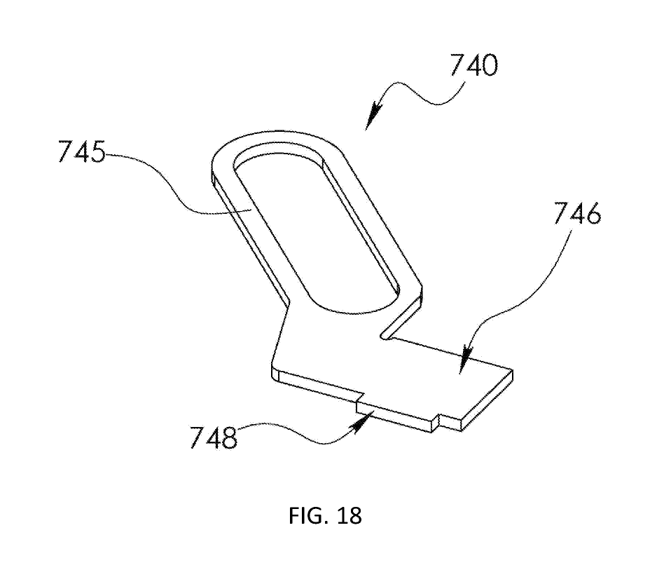

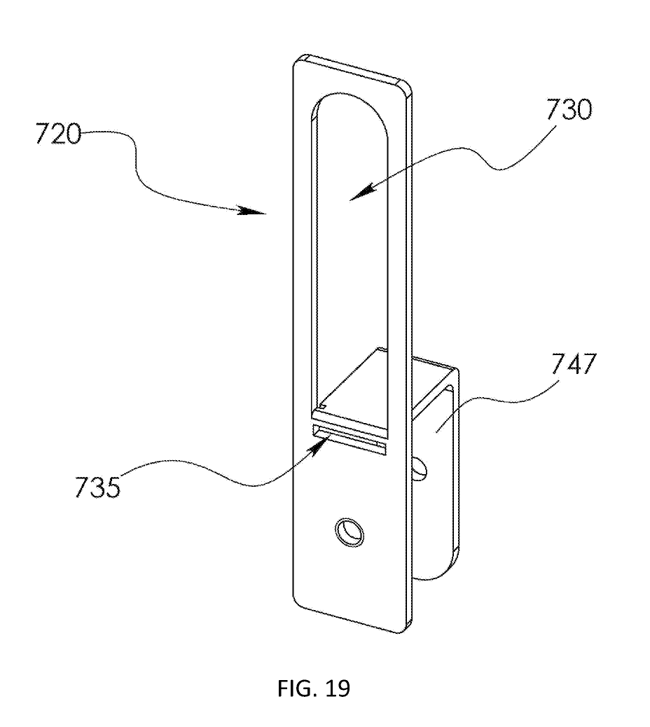

FIG. 18 shows another alternate embodiment of the deck plate 740 of the present disclosure. The deck plate 740 may be substantially planar, as shown, though it should be understood that it may have one or more curved surfaces and features. An alternate riser member 720 is shown in FIG. 19. The riser member 720 may include a rear connection feature or surface 747. In one embodiment, the rear connection surface 747 may be cut and bent when creating the riser slot 730. The riser member 720 may include a notch or slot 735 or other feature to aid in connecting the riser member 720 to the deck plate 740. Though the slot 735 is shown as enclosed on four sides, it should be understood that the slot 735 may be at least partially open on at least one side to aid in assembly of the deck plate 740 to the riser member 720.

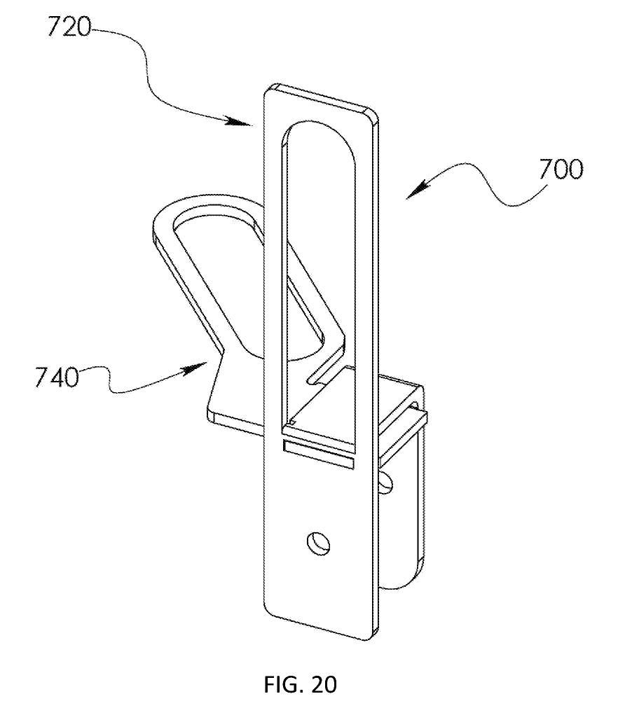

FIG. 20 shows an embodiment of the connector 700 which includes the deck plate 740 of FIG. 18 and the riser member 720 of FIG. 19. In the embodiment shown, the connector 700 places the majority of forces related to connection of the connector 700 to a container 170 on the riser member 720. The deck plate 740 may be held at least partially in place against the container 170 by the riser member 720. Such a design may allow for a kit of modular components to be used by a user, swapping out separate components from the kit as needed to achieve desired strengths, positions, sizes, and material characteristics of the components of the kit. This may also prevent needing to permanently or semi-permanently connect the riser member 720 to the deck plate 740. It should be understood that similar or related properties, features, and design elements may be combined or exchanged with other embodiments and variations as described in this disclosure. It should be understood that, depending on materials and applications of use, other connection means may also be used, such as clip-on features and magnets.

It should be understood that the various components, subassemblies, assemblies, and features discussed can be combined or removed in different combinations so as to achieve desired qualities and usability without deviating from the spirit or intent of the disclosure. It should also be understood that, depending upon the intended application and types of tools, materials, instruments, and attachments to be used with the device, the components may have a range of shapes, surfaces, materials, coatings, and additional features configured for the specific attachments, temperatures, ingredients, compounds, and environment to be used. It may also utilize other load support or connection means known in the art.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A device for connecting two or more objects, comprising:
a riser member with a first longitudinal axis; and
a deck plate comprising at least one surface which is substantially perpendicular to the first longitudinal axis;
wherein at least one of the riser member and the deck plate defines a first opening, and further wherein the first opening is configured to receive at least part of a first item, and wherein the deck plate further comprises a compression feature which is offset from the riser member and configured to seat at least partially against a feature of a second item on an opposing side of the feature of the second item from at least part of the riser member.

2. The device according to claim 1, further wherein the other of the riser member and the deck plate defines a second opening configured to receive at least part of a third item.

3. The device according to claim 1, further wherein the riser member defines a riser member opening which is elongated relative to the first longitudinal axis.

4. The device according to claim 3, further wherein the riser member opening is configured to allow for variable placement of the first item along the first longitudinal axis.

5. The device according to claim 1, further wherein the deck plate has a second longitudinal axis, and wherein the deck plate defines a deck plate opening which is elongated relative to the second longitudinal axis.

6. The device according to claim 5, further wherein the deck plate opening is configured to allow for variable placement of a third item along the second longitudinal axis.

7. The device according to claim 1, further wherein the riser member defines a first compression opening which is configured to receive a first adjustable compression member.

8. The device according to claim 7, further wherein the first adjustable compression member is a thumb screw.

9. The device according to claim 7, further wherein the deck plate defines a second compression opening configured to receive a second adjustable compression member.

10. The device according to claim 1, further wherein one of the riser member and the deck plate define a compression opening configured to receive a compression member, and the other of the riser member and the deck plate comprise a compression feature configured to be on an opposing side of the second item from the compression opening.

11. The device according to claim 1, further wherein the deck plate further comprises a platform which extends substantially away from the riser member.

12. The device according to claim 11, further wherein the platform is configured to at least partially overhang an opening in the second item.

13. The device according to claim 12, further wherein the platform extends away from the riser member at an angle that is less than 90° relative to the first longitudinal axis in a first orientation and substantially perpendicular to the first longitudinal axis in a second orientation.

14. The device according to claim 1, further wherein the deck plate is removably connected to the riser member.

15. The device according to claim 14, further wherein one of the deck plate and the riser member further comprises a tab which is configured to fit at least partially within a slot in the other of the deck plate and the riser member.

16. The device according to claim 1, further wherein the deck plate is welded to the riser member.

17. A kit of parts for connecting an object to a brewing container, comprising:
a connector; and
a thumb screw;
wherein the connector further comprises a riser member and a deck plate, wherein riser member defines a longitudinal axis, the deck plate comprises at least one surface which is substantially perpendicular to the longitudinal axis, the riser member defines a first opening, and the deck plate further comprises a platform which is substantially perpendicular to the riser and defines a second opening.

18. The kit of parts according to claim 17, further comprising a washer, and further wherein the riser member defines a first compression opening configured to receive the thumb screw, and the platform defines a second compression opening configured to receive the thumb screw, and the riser member and the deck plate are configured to be removably connectable.

19. A method of attaching at least one item to a container, comprising:
placing a connector proximate to an opening in the container;
connecting the connector to the container by means of compression; and
attaching the at least one item to the connector;
wherein the connector comprises a riser member and a deck plate, and further wherein at least part of the riser member is on an opposing side of a wall of the container from at least part of the deck plate when the connector is connected to the deck plate, and further wherein the connector is connected to the container by means of at least one threaded feature.

20. The method according to claim 19, further wherein the deck plate comprises a platform which extends substantially away from the riser member and wherein the deck plate is configured to at least partially overhang the opening in the container when the connector is connected to the container.
